(19) United States
(12) Patent Application Publication
(10) Pub. No.: US 2004/0193309 A1
(43) Pub. Date: Sep. 30, 2004

(54) Library checking systems

(75) Inventor: Howard Tilford, Hucknall Nottinghamshire (GB)

Correspondence Address: YOUNG & THOMPSON, 745 SOUTH 23RD STREET 2ND FLOOR, ARLINGTON, VA, 22202

(73) Assignee: DS LIMITED, Nottingham (GB)

(21) Appl. No.: 10/718,657

(22) Filed: Nov. 24, 2003

(30) Foreign Application Priority Data
Nov. 27, 2002 (GB) 0227616.0

(51) Int. Cl. G06F 7/00

(52) U.S. Cl. 700/215

(57) ABSTRACT

A library checking system for use with books provided with RFID tags comprises a terminal incorporating a housing within which a book is contained during checking, and an identification antenna for detecting the RFID tag of the book while within the housing and for supplying a signal identifying the book to a central processor. A book slot through which the book is insertable for checking opens into the housing, and an output from the housing is provided through which the book is discharged to a pick-up area in the event of the book being passed by the central processor as available for borrowing. A pivotable bookdrop flap is provided within the housing on which the book is supported during detection by the identification antenna, the flap being pivotable to cause the book to drop into a bookdrop bin in the event of the book not being passed by the central processor as available for borrowing. Such a system enables a book or other borrowable item to be automatically issued to a user when the item is passed by the central processor as being available for borrowing. In this case the user may collect the book from the pick-up area and can take the book out of the library without any manual checking system being required. In the event that the book is found not to be available for borrowing, the book is automatically passed to a secure receptacle, thus preventing the user from borrowing the book.

This invention relates to library checking systems, such as may be used for checking out books and audio/video items to be borrowed from a library, and/or for checking in such items to the library after borrowing.

### BACKGROUND TO THE INVENTION

Conventional library checking systems use a combination of a barcode system to track the location of a book or other borrowable item and a magnetic strip as a security device to prevent unauthorised removal of the book from the library. The main disadvantage of such a system is that the barcodes require each book to be individually opened and the barcode scanned when a book is to be borrowed, and each borrowed book to be individually scanned again when it is returned. Additionally deactivation of the magnetic strip when the item is borrowed and reactivation of the magnetic strip when it is returned are necessary.

As this is a labour intensive process, many libraries make use of bookdrop bins in which users may deposit returned books, the bins being periodically emptied and the books scanned. However this means that the return of books to the library is not registered in the library system until after the bookdrop bin has been emptied and the books scanned. To get over this problem library systems have been developed in which radio frequency identification devices are mounted on the borrowable items in the library, so that it is possible to detect when the items are returned to the library as soon as they have entered a designated area. The radio frequency identification device may also be used as a security feature to prevent unauthorised removal of the items from the library.

WO 99/64974 discloses a library checking system in which a receptacle is provided within a borrowed item returning location into which borrowed items may be inserted. The receptacle incorporates an antenna which detects insertion of a library item having a radio frequency identification device into the receptacle and which sends an identification code corresponding to the returned item to a processing unit which in turn updates the information on a database of returned items.

Whilst such a system enables return of a borrowable item to be detected as soon as it is returned to a designated area, it does not permit an item to be issued to a user in the absence of a member of the library staff to perform the necessary procedures to determine that the item is available for borrowing (for example if the item has not been reserved by another user or a required payment has been made).

It is an object of the invention to provide a library checking system which enables a borrowable item to be issued to a user without the intervention of library staff.

### SUMMARY OF THE INVENTION

According to the present invention there is provided a library checking system for use with a plurality of borrowable items provided with identifying means, the system comprising a housing within which a borrowable item is contained during checking, an identification unit for detecting the identifying means of the item while within the housing and for supplying a signal identifying the item to central processing means, an input to the housing through which the item is insertable for checking, an output from the housing through which the item is discharged to a pick-up area in the event of the item being passed by the central processing means as available for borrowing, and a movable floor within the housing on which the item is supported during detection by the identification unit, the movable floor being movable to cause the item to drop into a secure receptacle in the event of the item not being passed by the central processing means as available for borrowing.

Such a system enables a book or other borrowable item to be automatically issued to a user when the item is passed by the central processing unit as being available for borrowing. In this case the user may collect the book from the pick-up area and can take the book out of the library without any manual checking system being required. In the event that the book is found not to be available for borrowing, for example because the book has been reserved by another user or a payment is outstanding, the book is automatically passed to a secure receptacle, thus preventing the user from borrowing the book and enabling the book to be manually returned to the required library location in due course. This not only provides a considerable saving in library staff time but also speeds up the issuing of books within the library.

Where appropriate, the system may also be used for checking in books and other borrowable items which have previously been borrowed in a speedy and efficient manner.

The system may also be used in association with a verification unit adapted to accept a card, fingerprint or iris scan for verifying the identity of a user and for passing a verification signal to the central processing means, as well as in association with a payment unit for accepting payment from the user in the event that payment is required. If necessary a printer unit may be provided for issuing a receipt to the user, and in addition an instruction display, for example a TFT touchscreen, may be provided for displaying instructions to the user on use of the system.

The system may also be used in association with a security gate which prevents unauthorised removal of the item from the library and which is openable to provide user access to the pick-up area for collection of the item without setting off a security gate alarm in response to an authorisation signal from the central processing means.

### BRIEF DESCRITPION OF THE DRAWINGS

In order that the invention may be more fully understood, a preferred embodiment of library checking system in accordance with the invention will now be described, by way of example, with reference to the accompanying drawings, in which:

FIG. 1 is a perspective view of the self-issue library terminal of the preferred embodiment; and

FIG. 2 is a vertical section through such terminal.

### DETAILED DESCRITPION OF THE DRAWINGS

The self-issue library terminal to be described is intended to be located adjacent to an entry and/or exit of the library and incorporates a bookdrop so that a book or other item to be borrowed may be automatically issued to a user without staff intervention, and so that the borrowed item may be automatically returned to the bookdrop.

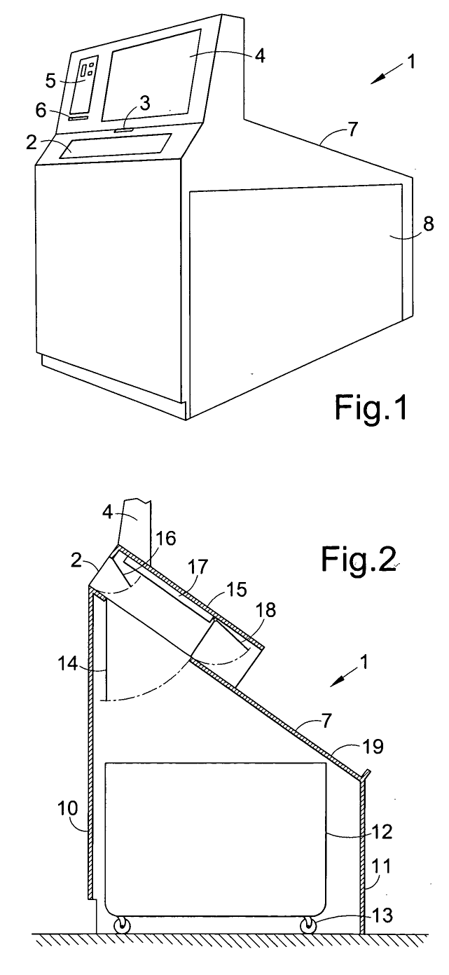

Referring to FIG. 1, the terminal 1 incorporates a book slot 2 into which a book or other item to be borrowed may be inserted, a card slot 3 for receiving the borrower's card, a TFT touchscreen 4 for displaying information to the user, a cash mechanism 5 permitting payment to be made by means of cash, a smart card or a credit/debit card for book fines or for borrowing non-book material, such as a video tape, and a printer slot 6 for issuing a receipt to the user in respect of any payment made. The terminal 1 incorporates an inclined upper surface 7 defining a book pick-up area and has an openable door 8 by way of which a bookdrop bin may be removed from the terminal for emptying.

The operation of the system will now be described with reference to the vertical section through the terminal of FIG. 2 showing the front and back walls 10, 11 of the terminal, and the bookdrop bin 12 within the terminal provided with wheels 13 enabling the bin 12 to be easily removed from the terminal through the open door 8. The inclined upper surface 7 extends above the bookdrop bin 12 and incorporates a pivotable bookdrop flap 14 within a housing 15 into which the book is inserted when it is passed through the slot 2.

In use of the terminal 1 to borrow a book, the borrower inserts his card into the slot 3, and library management software within a central processor verifies the borrower's identity from information read from the card. A message then appears on the touchscreen 4 instructing the user to insert the first book to be borrowed through the book slot 2. In response to this instruction the borrower pushes the book into the slot 2 such that the sprung flap 16 is pivoted inwardly and the book is supported on the flap 14 (which is in its upward position) within the housing 15, the sprung flap 16 returning to its position closing off the slot 2 after the book has been fully inserted. A radio frequency identification (RFI) antenna 17 within the housing 15 detects the RFID tag on the book and passes information concerning the identity of the book to the central processor, and the central processor causes messages to be displayed to the user on the touchscreen 4. If payment is required, the borrower is instructed to insert cash or a card into the payment mechanism 5. If the requested payment is not made, or if the borrower is not authorised to borrow the book for some other reasons (e.g. because the book has been reserved), a solenoid actuator (not shown) is operated to move the flap 14 downwardly so that the book falls into the bookdrop bin 12, the flap 14 being automatically returned to its upward position after this operation. If payment is made or the transaction is otherwise authorised by the system, an issue flap 18 is automatically opened by a solenoid actuator (not shown) to allow the book to slide down the inclined surface 7 to a book pick-up area 19 from which the book may be collected by the borrower.

If further books or other items are to be borrowed by the same borrower this sequence of operations is repeated until all items have been passed through the housing 15, and the borrower is then instructed to remove his card from the slot 3. Where a security gate is associated with the system, the security gate is then unlocked to enable the borrower to pass through the gate without setting off a security gate alarm and collect the items from the pick-up point 19. As an additional security device a web camera may be associated with the system which is started as soon as the borrower's card is inserted and photographs only when movement is detected. Such security devices are particularly advantageous in libraries with few or no staff.

Various modifications of the above described system are possible within the scope of the invention. For example, instead of only one bookdrop flap 14 being incorporated in the inclined surface 7, more than one such bookdrop flap 14 may be provided for guiding items into two or more different bins according to different rejection criteria. For example one flap may be operated for guiding an item into an on-reserve bin, whereas another item may be operated to guide an item into a return bin. Furthermore the system may be adapted to detect types of identification tag other than the RFID tag, such as a bar code or a magnetic strip or some combination of the different types of identification tag.

It should be appreciated that the same terminal may be used for accepting returned items. In this case the sequence of steps to be performed by the borrower is similar, including insertion of the borrower's card into the slot 3 and the possibility of payment being required in the event of late return. In this case each returned item is caused to drop into the bin 12 (or optionally into an on-reserve bin where provided).

1. A library checking system for use with a plurality of borrowable items provided with identifying means, the system comprising a housing within which a borrowable item is contained during checking, an identification unit for detecting the identifying means of the item while within the housing and for supplying a signal identifying the item to central processing means, an input to the housing through which the item is insertable for checking, an output from the housing through which the item is discharged to a pick-up area in the event of the item being passed by the central processing means as available for borrowing, and a movable floor within the housing on which the item is supported during detection by the identification unit, the movable floor being movable to cause the item to drop into a secure receptacle in the event of the item not being passed by the central processing means as available for borrowing.

2. A system according to claim 1, wherein the movable floor comprises a flap which is pivoted downwardly from its support position to cause the item to drop into the receptacle.

3. A system according to claim 2, wherein an electrical actuator is provided for pivoting the flap downwardly to cause the item to drop into the receptacle.

4. A system according to claim 1, wherein the identification unit is adapted to detect radio frequency, bar code or magnetic strip identifying means or any combination of such identifying means on the items.

5. A system according to claim 1, wherein the input to the housing incorporates a sprung flap through which the item is insertable and behind which the sprung flap closes when the item is in position on the movable floor for detection by the identification unit.

6. A system according to claim 1, wherein the output from the housing incorporates an output door which is movable between a closed position retaining the item on the movable floor for detection by the identification unit and an open position when the item is passed by the central processing unit as available for borrowing.

7. A system according to claim 6, wherein the output door comprises a flap which is pivotable outwardly from its closed position to cause the item to be discharged to the pick-up area.

8. A system according to claim 7, wherein an electrical actuator is provided for pivoting the flap outwardly to cause the item to be discharged to the pick-up area.

9. A system according to claim 1, wherein the movable floor is incorporated in an inclined surface such that the item is slidable down the inclined surface when it passes through the input and the output.

10. A system according to claim 1, wherein a closed chamber is provided for containing the receptacle for items not passed by the central processing means as available for borrowing.

11. A system according to claim 10, wherein the closed chamber is provided with a door which may be opened to enable the receptacle to be removed.

12. A system according to claim 1, wherein a verification unit adapted to accept a card, fingerprint or iris scan is provided for verifying the identity of a user and for passing a verification signal to the central processing means.

13. A system according to claim 1, wherein a payment unit is provided for accepting payment from a user in the event that payment is required and for passing a payment signal to the central processing means.

14. A system according to claim 1, wherein an instruction display is provided for displaying instructions to the user on use of the system in response to instruction signals from the central processing means.

15. A system according to claim 1, wherein a printer unit is provided for issuing a receipt to the user in response to an instruction signal from the central processing means.

16. A system according to claim 1, wherein a security gate is provided which is openable to provide user access to the pick-up area for collection of the item without setting off a security gate alarm in response to an authorisation signal from the central processing means.
